(19) United States
(12) Patent Application Publication
(10) Pub. No.: US 2010/0253245 A1
(43) Pub. Date: Oct. 7, 2010

(54) METHOD, SYSTEM AND CURRENT LIMITING CIRCUIT FOR PREVENTING EXCESS CURRENT SURGES

(75) Inventors: Zhanqi DU, Baldwin Park, CA (US); Peter W. SHACKLE, Rolling Hills Estates, CA (US)

Correspondence Address: OLIFF & BERRIDGE, PLC, P.O. BOX 320850, ALEXANDRIA, VA, 22320-4850, US

(73) Assignee: LIGHTECH ELECTRONIC INDUSTRIES LTD., LOD (IL)

(21) Appl. No.: 12/418,935

(22) Filed: Apr. 6, 2009

(51) Int. Cl. H05B 37/02; H02H 9/02

(52) U.S. Cl. 315/310; 361/93.9

(57) ABSTRACT

The present invention relates to a method, system and current limiting circuit configured to limit the excess output current passing through a load, said current limiting circuit comprising a resistor connected in series with said load and in parallel with a switch, which is initially turned OFF, wherein said switch is turned ON, thereby shorting said resistor, when the output voltage applied to said load is decreased by a predetermined level.

### FIELD OF THE INVENTION

The present invention relates generally to the field of light illumination. More particularly, the present invention relates to providing a method, system and electronic circuit for substantially preventing excess initial output current surges when connecting a load (e.g., one or more light sources, such as LEDs (Light Emitting Diodes)), to a driver, such as a constant current driver.

### BACKGROUND OF THE INVENTION

In recent years, the usage of LED illumination instead of other kinds of illumination (such as the fluorescent illumination, incandescent bulb illumination, and the like), has significantly increased due to the increasing luminosity of LED devices and due to their continuously decreasing costs. Although most people around the world still use fluorescent and incandescent bulb lighting, development of low-cost and efficient LED illuminating devices has recently accelerated rapidly.

However, modern light emitting diodes have relatively stringent current requirements. If excess currents are passed through them, they may be damaged by the associated heat. Most LED driver circuits, which generate a constant current to be provided to a LED load, have a capacitor at the output, which in turn is used to smooth out high frequency fluctuations. When the LED load is not connected, the output voltage goes up to its compliance voltage limit, which is usually set at 60V (Volts) to meet UL (Underwriters Laboratories®) safety requirements. On the other hand, when the LED load is connected, the voltage on the LED load can vary, for example, from 40V (e.g., for twelve LEDs) down to 12V (e.g., for three LEDs). With a difference between the above 60V and 12V (60V−12V=48V), the result is that a relatively large current flows through the LEDs as the capacitor at the output stage of the LED driver discharges from 60V down to 12V. This is normally a one time event, except that some systems involve repeatedly switching the output ON and OFF, such as for precision light exposure purposes in industrial equipment.

Problems related to limiting output surges have been recognized in the prior art, and various methods have been proposed to provide a solution. It should be noted that according to the prior art, there are two main kinds of limiters: those which sense the fall in the output voltage caused by the relatively large surge (so called “voltage sensing limiters”) and those which sense the passing current, regardless of the voltage, and react to the current (so called “current sensing limiters”).

U.S. Pat. No. 5,374,887 discloses an inrush current limiting circuit that contains a FET (Field Effect Transistor) as an active component, which is controlled by a network of passive components. The network includes a gate control circuit for controlling the operation of the FET and a negative feedback circuit, which responds to the load voltage during the transient state. Thus, the circuit of U.S. Pat. No. 5,374,887 is actually a voltage sensing circuit, in which a FET is placed in series with the load, and its gate is biased through a resistor connected across the power rails. According to U.S. Pat. No. 5,374,887, the normal operation involves permanent connection of the load, and connecting the power supply. The FET is initially switched OFF, and when the power supply is connected, it is slowly switched ON, thereby connecting the power supply to the load. Then, the power rail is pulled down and a capacitor connected between the power rail and the gate of the FET transfers a downward pulse to the gate, and thus turns OFF the FET.

U.S. Pat. No. 7,262,559 presents a power supply that provides power to a LED light source having a variable number of LEDs wired in series and/or in parallel. The power supply uses current and voltage feedback to adjust power provided to the LED light sources, and as a result to protect them. A feedback controller compares the sensed current and sensed voltage to reference signals and generates feedback signals, which are processed by a power factor corrector to adjust the current flow through the transformer supplying current to the LED light sources. Thus, the circuit of U.S. Pat. No. 7,262,559 is actually a current sensing circuit, in which a FET is provided in series with the load, and the gate of the FET is normally pulled up to a positive rail potential. In addition, another resistor is connected in series with the FET, with a n-p-n transistor connected across the resistor (the collector of the n-p-n transistor is connected to the gate of the FET). When the current becomes sufficient, then the voltage generated across the resistor is sufficient enough to turn ON the n-p-n transistor, so that the gate of the FET is pulled down, thus turning OFF the FET and as a result, limiting the current.

The prior art limitations are well known and there is a continuous need to provide a current limiting circuit, which can limit the excess current surge to a relatively low level, such as approximately a hundred millamperes. In addition, there is a need to provide a current limiting circuit that reacts relatively fast to a current surge of substantially any level. Further, there is a need in the prior art to provide a current limiting circuit, which does not involve continuous power dissipation and eliminates the need in providing one or more resistors in series with a load, such as a LED load.

### SUMMARY OF THE INVENTION

The present invention relates to providing a method, system and electronic circuit for substantially preventing excess initial output current surges when connecting a load (e.g., one or more light sources, such as LEDs (Light Emitting Diodes)), to a driver, such as a constant current driver.

According to an embodiment of the present invention, a current limiting circuit is configured to limit the excess output current passing through a load, said current limiting circuit comprising a resistor connected in series with said load and in parallel with a switch, which is initially turned OFF, wherein said switch is turned ON, thereby shorting said resistor, when the output voltage applied to said load is decreased by a predetermined level.

According to another embodiment of the present invention, the current limiting circuit is integrated within a driver that is operatively coupled to the load.

According to a particular embodiment of the present invention, the driver is a constant current driver.

According to another particular embodiment of the present invention, the driver is a Light Emitting Diode (LED) driver.

According to still another embodiment of the present invention, the load is a light source.

According to still another embodiment of the present invention, the light source is at least one Light Emitting Diode (LED).

According to a further embodiment of the present invention, the switch is a transistor.

According to still a further embodiment of the present invention, the transistor is partially operated in a linear mode.

According to still a further embodiment of the present invention, the transistor is operated so as to control the rate of decrease of the output voltage.

According to still a further embodiment of the present invention, the switch and the resistor are operatively coupled to one or more additional resistors and to one or more additional switches configured to control the rate of decrease of the output voltage to the substantially equilibrium level,

According to another embodiment of the present invention, a current limiting circuit is configured to limit the excess output current passing through a load, said current limiting circuit comprising a resistor connected in series with said load and in parallel with a switch, which is initially turned OFF, wherein said switch is configured to be turned ON, thereby shorting said resistor, when the output voltage is decreased by a predetermined level configured to allow a substantially brief surge of said excess output current to be passed through said load, and said switch configured to be turned OFF again when said output voltage is further decreased by an additional predetermined level, thereby continuously turning said switch ON and OFF until said output voltage is decreased to a substantially equilibrium level, at which said switch is left turned ON.

According to still another embodiment of the present invention, the output current passes through the load in brief pulses in excess of the predetermined current level until said predefined current level is substantially achieved.

According to an embodiment of the present invention, a method of limiting the excess output current passing through a load comprises:
a) passing the excess output current through a resistor that is connected in series with a load and in parallel with a switch, which is initially turned OFF; and
b) when the output voltage is decreased by a predetermined level, turning ON said switch, thereby shorting said resistor and enabling further decreasing said output voltage to a substantially equilibrium level.

According to another embodiment of the present invention, a method of limiting the excess output current passing through a load comprises:
a) passing the excess output current through a resistor that is connected in series with a load and in parallel with a switch, which is initially turned OFF;
b) when the output voltage is decreased by a predetermined level, turning ON said switch, thereby shorting said resistor and allowing a substantially brief surge of said excess output current to be passed through said load;
c) when the output voltage is further decreased by an additional predetermined level, turning OFF said switch; and
d) continuously repeating steps (c) and (d) until said output voltage is decreased to a substantially equilibrium level, at which said switch is left turned ON.

According to an embodiment of the present invention, a system is configured to limit the excess output current passing through a load, said system comprising:
a) a driver configured to provide current to a load; and
b) a current limiting circuit operatively coupled to said driver and to said load, said current limiting circuit comprising a resistor connected in series with said load and in parallel with a switch, which is initially turned OFF, wherein said switch is turned ON, thereby shorting said resistor, when the output voltage applied to said load is decreased by a predetermined level.

According to another embodiment of the present invention, a system is configured to limit the excess output current passing through a load, said system comprising:
a) a driver configured to provide current to a load; and
b) a current limiting circuit operatively coupled to said driver and to said load, said current limiting circuit comprising a resistor, which is connected in series with said load and in parallel with a switch being initially turned OFF, wherein said switch is configured to be turned ON, thereby shorting said resistor, when the output voltage is decreased by a predetermined level configured to allow a substantially brief surge of said excess output current to be passed through said load, and said switch configured to be turned OFF again when said output voltage is further decreased by an additional predetermined level, thereby continuously turning said switch ON and OFF until said output voltage is decreased to a substantially equilibrium level, at which said switch is left turned ON.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1 is a schematic block diagram of a system having a current limiting circuit, according to an embodiment of the present invention;

FIGS. 2A to 2C are schematic illustrations of a current limiting circuit, according to different embodiments of the present invention; and

FIGS. 3A and 3B are sample flow charts of operation of a current limiting circuit, according to different embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

In the following detailed description, numerous specific details are set forth in order to provide a thorough understanding of the invention. However, it will be understood by those skilled in the art that the present invention may be practiced without these specific details. In other instances, well-known methods, systems, procedures, components, units, circuits and the like have not been described in detail so as not to obscure the present invention.

Hereinafter, whenever the term “LED” (“Light Emitting Diode”) is mentioned, it should be understood that it refers to any type of a light illumination source, such as a LED-based source, an incandescent source (a filament lamp, a halogen lamp, etc.), a high-intensity discharge source (sodium vapor, mercury vapor, a metal halide lamp and the like), a fluorescent source, a phosphorescent source, laser, an electroluminescent source, a pyro-luminescent source, a cathode-luminescent source using electronic satiation, a galvano-luminescent source, a crystallo-luminescent source, a kine-luminescent source, a candle-luminescent source (a gas mantle, a carbon arc radiation source, and the like), a radio-luminescent source, a luminescent polymer, a thermo-luminescent source, a tribo-luminescent source, a sono-luminescent source, an organic LED-based source and any other type of light illumination source.

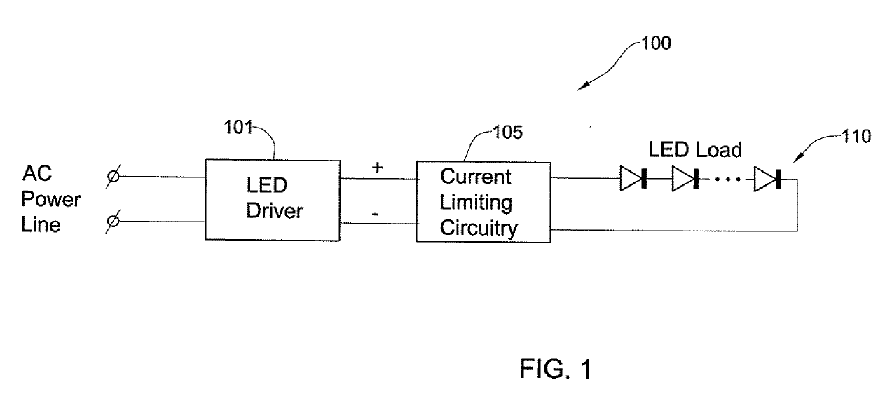

FIG. 1 is a schematic block diagram of system 100 having a current limiting circuit 105, according to an embodiment of the present invention. System 100 comprises a driver (e.g., a LED driver 101) for receiving AC (Alternating Current) line voltage (e.g., from a dimmer (not shown)) and providing current to a load, such as LED load 110; and current limiting circuit 105 for limiting an excess surge and limiting a level of the excess output current provided to LED load 110, such as approximately to a hundred milliamperes [mA].

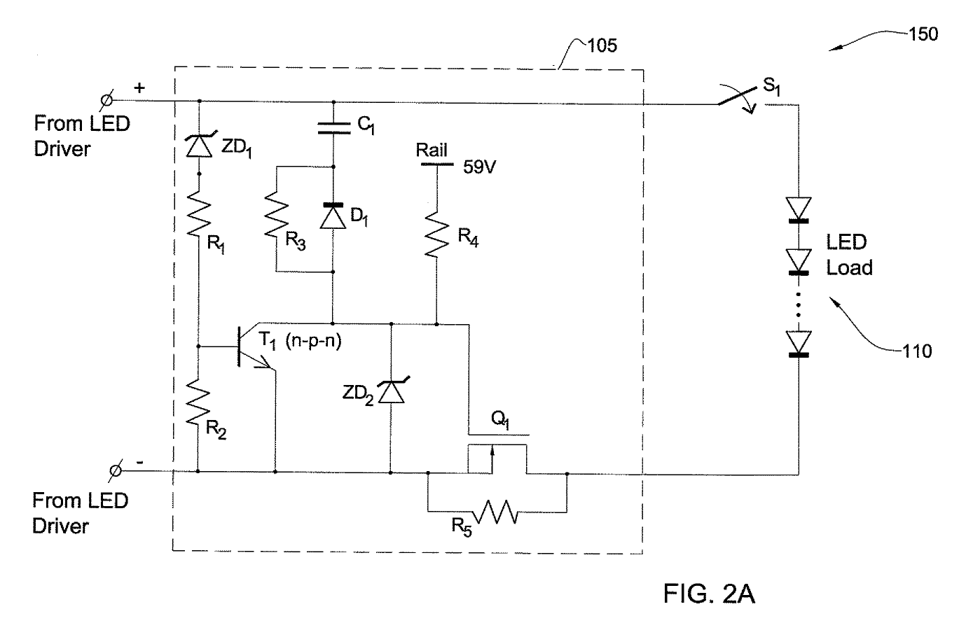

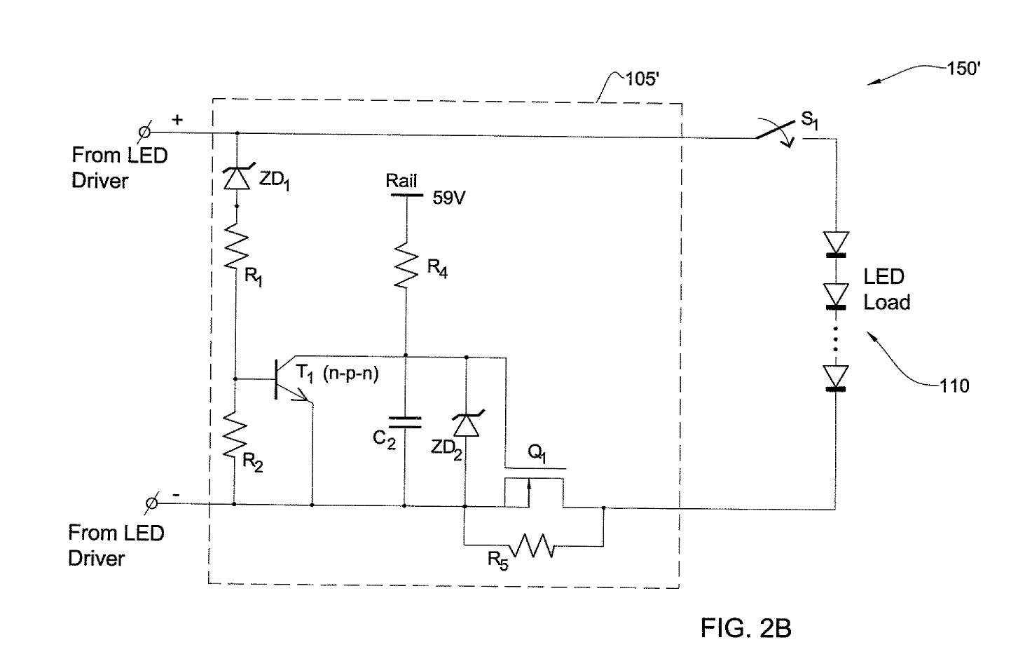

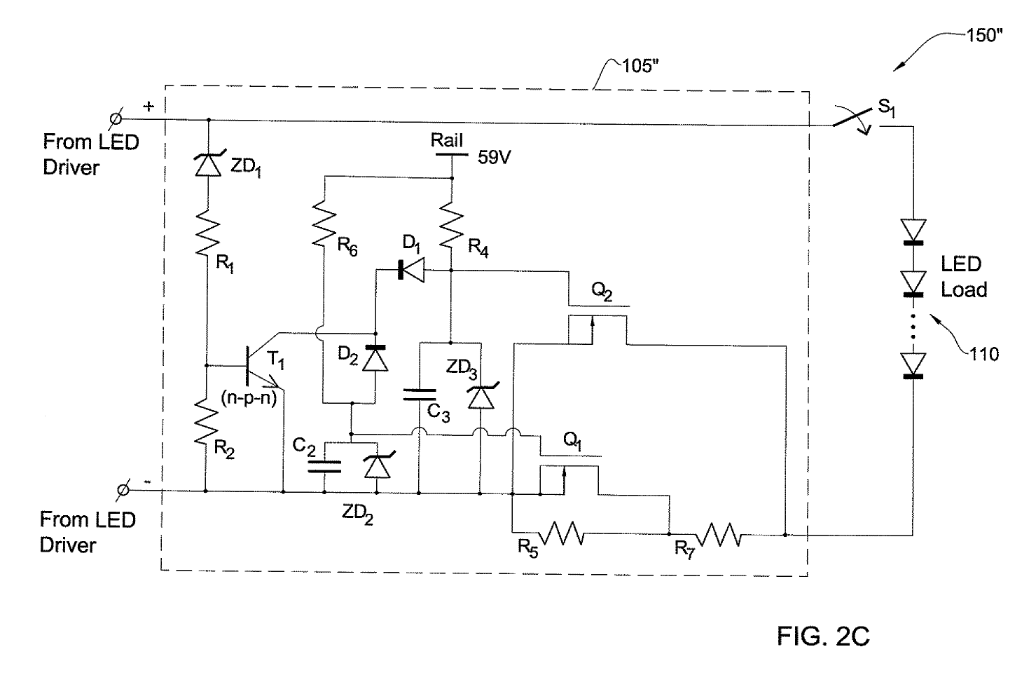

FIG. 2A is a schematic illustration 150 of a current limiting circuit 105, according to an embodiment of the present invention. According to this embodiment, current limiting circuit 105 comprises: transistor Q₁ that is, for example, a Field Effect Transistor (FET); zener diode ZD₁ that is, for example, 47 Volts zener diode; zener diode ZD₂ that is, for example, 6.8 Volts zener diode; n-p-n transistor T₁ that is, for example, a n-p-n BJT (Bipolar Junction Transistor) transistor of a “2N3904” model (developed by the ON-Semiconductor® company, located in the United States). Further, current limiting circuit 105 comprises, for example, resistors R₁ to R₅, while each of resistors R₁, R₃ and R₄ has a value of 100KΩ (KiloOhm), resistor R₂ has a value of 1MΩ (MegaOhm) and resistor R₅, which is connected in parallel with FET Q₁, has a value of 100Ω (Ohm).

According to an embodiment of the present invention, the n-p-n transistor T₁ is turned ON only when the output voltage (on LED load 110) is up at its “limiting high voltage”, which is the maximum output voltage of LED driver 101 (that is usually predefined by safety requirements), while using the 47V zener diode ZD₁ to sense the voltage reaching the corresponding high level. Transistor T₁ turns OFF transistor Q₁, when the output is open-circuited (when switch S₁ is open). It should be noted that conventional LED driver 101 is generally bound by the requirements of SELV (Safety Extra-Low Voltage) standard in Europe or “Class 2” standard in the United States, which require that the output voltage should not exceed 60V DC (Direct Current). So even though conventional LED driver 101 (FIG. 1) is usually designed to force a constant current through a load that is connected to it, said LED driver 101 can only do so up to above limiting voltage of 60 Volts. If the impedance of connected LED load 110 is relatively high, such that more than 60 Volts is required to force the desired current, then the output voltage is raised up to 60V and remains at such a level until lower load impedance is connected. Thus, the meaning of the above “limiting high voltage” is generally the maximum output voltage of LED driver 101, which is usually predefined by safety requirements.

According to an embodiment of the present invention, when switch S₁ is open, then the output voltage of LED driver 101 (FIG. 1) goes to 59V, and transistor (switch) T₁ is turned ON. Then, when LED load 110 is connected (e.g., by closing switch S₁), the current starts to flow through resistor R₅, which has such a resistance value (e.g., 100Ω) that the current which flows through said resistor R₅ has similar value to the current that would normally flow through said LED load 110. As a result, the output capacitor (not shown) of LED driver 101 starts discharging. Also, when the power rail falls by a predetermined level (e.g., by approximately 13V from 60V to 47V), then transistor T₁ is turned OFF and the 47V zener diode ZD₁ turns OFF, so that the charge coming through resistor R₄ is able to raise the potential of gate of transistor Q₁, and as a result, to switch ON said transistor Q₁. Then, said output capacitor of LED driver 101 is discharged, and a relatively rapid voltage fall (i.e., the voltage falls by an additional predetermined level) is transferred by capacitor C₁ through diode D₁ to the gate of said transistor Q₁, which turns said transistor Q₁ OFF again. This cycle continuously repeats, thereby switching transistor Q₁ ON and OFF again, with relatively little pulses of current (such as 0.5 A Amperes) coming through, each time said transistor (switch) Q₁ turns ON. In addition, each time the rail voltage falls a little, an impulse is sent through capacitor C₁ and diode D₁ to bias OFF the gate of transistor Q₁, and thus limit the rate of the voltage fall. Finally, after a series of pulses, which can last for example, two milliseconds, transistor Q₁ is permanently switched ON because the rail voltage settles at a substantially steady voltage below 47V. As a result, the maximum excess current surge through LED load 110 can be approximately a hundred milliAmperes, for example. It should be noted that according to an embodiment of the present invention, current limiting circuit 105 has flexibility to self-adapt to connecting (changing) different loads 110 (such as connecting LED load 110 containing, for example, one LED, three LEDs, six LEDs, etc.).

In addition, according to an embodiment of the present invention, transistor Q₁ substantially does not get “turned hard ON” during the current limiting circuit 105 operation. Instead, it turns ON partially in a “linear mode” of operation, and relatively briefly dissipates energy from the discharging output capacitor (not shown) of LED driver 101.

Also, it should be noted that according to an embodiment of the present invention, it is assumed that LED driver 101 is a constant current driver. In addition, FET transistor Q₁ is initially turned OFF.

According to an embodiment of the present invention, diode D₁ is provided because otherwise capacitor C₁ could also turn ON the FET Q₁ and the current limiting circuit 105 could oscillate. Also, due to providing diode D₁, the capacitor C₁ can only turn OFF the FET Q₁, and as a result, a substantially stable operation of said circuit 105 can be achieved. In addition, resistor R₃ across diode D₁ is used to reset the capacitor C₁ voltage after each operation (i.e., after each event, in which LED load 110 is connected to the output and the current surge through said LED load 110 is limited by current limiting circuit 105). In addition, resistor R₂ is used to absorb voltage leakage through zener diode ZD₁, which might otherwise cause n-p-n transistor T₁ to turn ON, when this is not intended. Such, resistor R₂ can have a value of 1MΩ, for example. Further, 6.8V zener diode ZD₂ enables limiting the voltage on the gate of transistor Q₁ to a predefined level (the level that is considered to be a “safe” level, such as 5V to 20V).

According to another embodiment of the present invention, a terminal of resistor R₄ is connected to the predefined power rail (e.g., 59 Volts rail), which feeds the LED driver 101. This ensures that transistor Q₁ is turned ON in the final equilibrium state (level), substantially preventing any power dissipation in resistor R₅, which in turn can be, for example, a 100Ω resistor. According to another embodiment of the present invention, said above terminal of resistor R₄ is connected to a terminal of switch S₁ instead of said 59V rail. It should be noted that according to this embodiment, the current limiting circuit 105 may not be used with a single LED as load 110, because there may be not enough voltage to properly turn ON the gate of transistor Q₁.

It should be noted that according to an embodiment of the present invention, current limiting circuit 105 reacts relatively fast to substantially any current surge, and does not involve continuous power dissipation. In addition, it should be noted that the current passes through LED 110 load in relatively small and brief pulses, in excess of the normal current, until the normal current is achieved (in a substantially steady way). Also, when LED load 110 is connected, then the excess current that passes to said LED load 110 for an initial period of time, before commencing the normal current level (such as 0.5 Amperes), is substantially low and can be, for example, no more than twice said normal current level. Finally, after a series of pulses, which can last for example, two milliseconds, transistor Q₁ is permanently switched ON, because the rail voltage has become substantially steady at a voltage below 47V. The maximum excess current surge can be as low as a hundred milliAmperes. Further, it should be noted that according to an embodiment of the present invention at least one resistor (such as resistor R₅) is connected in series with an output port of current limiting circuit 105 to limit the initial current flow out of LED driver 101 and into LED load 110. The value of said resistor R₅ is chosen so that the initial current which flows approximates the intended LED driver 101 current. It is this current through R₅ that starts discharging the output capacitor of the LED driver 101 until it gets down to a voltage below 47V, after which point transistor Q₁ starts turning ON. In the steady state, resistor R₅ is permanently shorted by a switch (such as transistor Q₁), when LED load 110 is connected to said current limiting circuit 105. As a result, the power dissipation of system 100 (FIG. 1) is relatively low.

FIG. 2B is another schematic illustration 150′ of a current limiting circuit 105′, according to another embodiment of the present invention. According to this embodiment of the present invention, the turn ON of the transistor Q₁ can be delayed by a predefined time period (for example, by a hundred milliseconds) after switch S₁ is closed. In this embodiment, circuit 105 does not self adjust to the voltage of the LED load 110 (that depends, for example, on a number of LEDs within said LED load 110), and it can be used for a fixed known LED load 110. According to this embodiment, capacitor C₁, diode D₁ and resistor R₃ are removed, and capacitor C₂ is placed across 6.8V zener diode ZD₂. The time constant is set by values of resistor R₄ and capacitor C₂, which can be for example, 100 KOhm and 50 [nF] (nanoFarad), respectively.

FIG. 2C is still another schematic illustration 150″ of a current limiting circuit 105″, according to still another embodiment of the present invention. According to this embodiment of the present invention, two switches such as transistors Q₁ and Q₂ which are operatively coupled to resistors R₅ and R₇, are turned ON in succession. When LED load 110 is connected, first the output capacitor (not shown) of the LED driver 101 (FIG. 1) is pulled down in voltage by the current passing through resistors R₅ and R₇. When the voltage has declined significantly in a controlled manner, then switch Q₁ is “timed” to turn ON, pulling the output voltage down further by a predetermined level. After a further time period of orderly discharging of the output capacitor and further decreasing the output voltage (by an additional predetermined level), transistor Q₂ is “timed” to turn ON to allow a final relatively minor surge of current and the commencement of normal operation (i.e., the operation in which there is substantially no current limiting). According to an embodiment of the present invention, this process is as follows: when the rail is at 59 Volts, then transistor T₁ is turned ON, and transistors Q₁ and Q₂ are switched OFF. On the other hand, when LED load 110 is connected, current flows through resistors R₅ and R₇ and pulls down the voltage of the LED driver output capacitor by a predetermined level, such as below 47V. At this point, transistor (switch) T₁ is turned OFF. In addition, resistor R₆ and capacitor C₂ have such values that transistor Q₁ is switched ON first. After a further period of time, determined by the time constant of resistor R₄ and capacitor C3, transistor Q₂ turns ON and the normal operation (i.e., the operation in which there is substantially no current limiting and the output voltage is in an equilibrium level) is resumed.

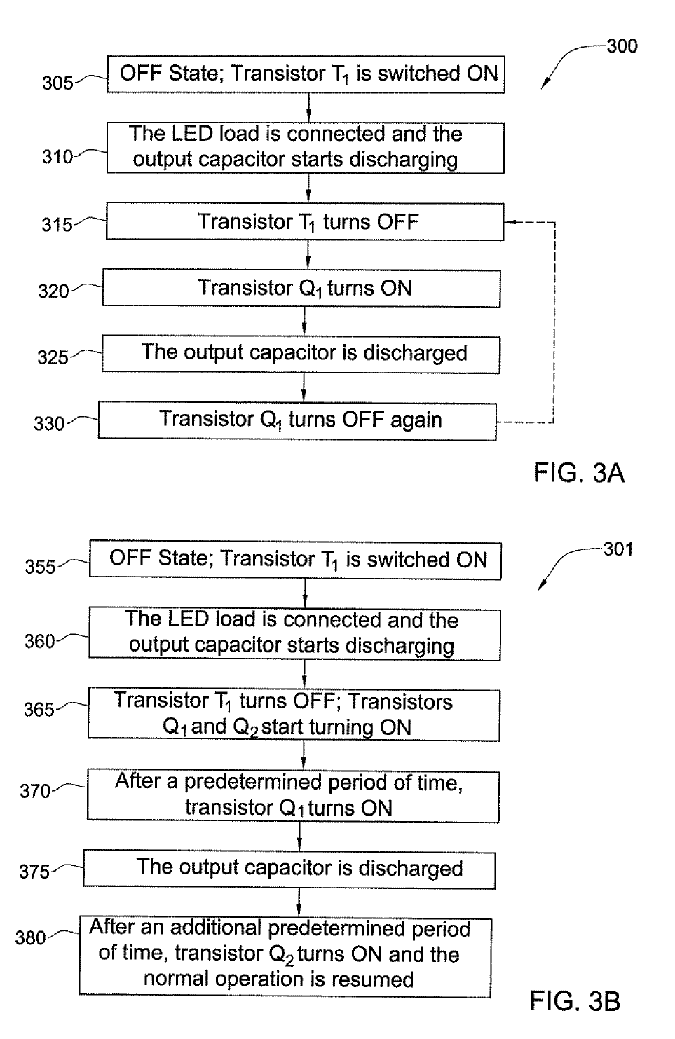

FIG. 3A is a sample flow chart 300 of operation of current limiting circuit 105 (FIG. 2A), according to an embodiment of the present invention. At step 305, when switch S₁ is open, then current limiting circuit 105 is in OFF state. Thus, the output voltage of LED driver 101 (FIG. 1) goes to 59V, and transistor T₁ is switched ON. At step 310, when LED load 110 (FIG. 2A) is connected, the current starts to flow through resistor R₅, which has such a resistance value (e.g., 100Ω) that the current which flows through said resistor R₅ has similar value to the current that would normally flow through said LED load 110. As a result, the output capacitor (not shown) of LED driver 101 starts discharging. Also, when the power rail falls (e.g., by approximately 13V from 60V to 47V), then transistor T1 is turned OFF at step 315, and the 47V zener diode ZD₁ turns OFF, so that the charge coming through resistor R₁ is able to raise the potential of gate of transistor Q₁, and as a result, to switch ON said transistor Q₁ at step 320. Then, said output capacitor of LED driver 101 is discharged, and a relatively rapid voltage fall is transferred by capacitor C₁ through diode D₁ to the gate of said transistor Q₁, which turns said transistor Q₁ OFF again. The cycle (steps 315 to 330) repeats, with relatively little pulses of current (such as 0.5 A) coming through, each time the FET transistor Q₁ turns ON. It should be noted that according to an embodiment of the present invention, transistor Q₁ substantially does not get “turned hard ON” during the current limiting circuit 105 operation. Instead, it turns ON partially in a “linear mode” of operation, and relatively briefly dissipates energy from the discharging output capacitor (not shown) of LED driver 101. Finally, after a series of pulses, which can last, for example, from 2 msecs (milliseconds) to 400 msecs, transistor Q₁ is permanently switched ON because the LED driver output voltage substantially stabilizes below 47V. The maximum excess current surge through LED load 110 can be as low as a hundred milliAmperes, for example.

FIG. 3B is a sample flow chart 301 of operation of current limiting circuit 105″ (FIG. 2C), according to an embodiment of the present invention. At step 355, current limiting circuit 105″ is in the OFF state and no load (such as LED load 110 (FIG. 2C)) is connected. In addition, the power rail is at 59 Volts, and thus transistor T₁ is switched ON. At step 360, LED load 110 is connected (e.g., by closing switch S₁), and the output capacitor (not shown; provided in parallel to the output of LED driver 101 (FIG. 1)) starts discharging through resistors R₅ and R₇. Then, when the output voltage falls by a predetermined level, such as below 47 Volts, transistor T₁ turns OFF so that transistors Q₁ and Q₂ start turning ON, at step 365. Further at step 370, after a predetermined time period (such as 2 milliseconds), transistor Q₁ turns ON. The output capacitor is then, at step 375, discharged through resistor R₇ and transistor Q₁. Still further at step 380, after an additional predetermined time period (such as 4 milliseconds), transistor Q₂ turns ON and the normal operation (i.e., the operation in which there is substantially no current limiting) is resumed.

Below is presented a table (Table 1) with sample characteristics of electronic components of the current limiting circuit, according to an embodiment of the present invention.

TABLE 1
Sample characteristics of several electronic components of a
current limiting circuit, according to an embodiment of the
present invention.

| | | Components |
|---|---|---|
| Electronic components | Symbols | characteristics |
| Capacitors | C₁ | 10 nF, 63 V |
| Diodes | D₁ | “1N4148” model, |
| | | developed by Philips ® |
| | Q₁ | MOSFET, 5 A, 100 V |
| Transistors | T₁ | “2N3904” model, |
| | | developed by ON- |
| | | Semiconductor ® |
| Resistors | R₁, R₃, R₄ | 100 KΩ |
| | R₂ | 1 MΩ |
| | R₅ | 100 Ω |
| Zener Diode | ZD₁ | 47 V Zener Diode |
| Zener Diode | ZD₂ | 6.8 V Zener Diode |

It should be noted that according to an embodiment of the present invention, transistors Q₁ and Q₂ can be, for example, IGBT (Insulated Gate Bipolar Transistor), MOSFET (Metal-Oxide-Semiconductor Field-Effect Transistor) or any other bipolar or field effect transistors.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A current limiting circuit configured to limit the excess output current passing through a load, said current limiting circuit comprising a resistor connected in series with said load and in parallel with a switch, which is initially turned OFF, wherein said switch is turned ON, thereby shorting said resistor, when the output voltage applied to said load is decreased by a predetermined level.

2. The current limiting circuit according to claim 1, wherein said current limiting circuit is integrated within a driver that is operatively coupled to the load.

3. The current limiting circuit according to claim 2, wherein the driver is a constant current driver.

4. The current limiting circuit according to claim 2, wherein the driver is a Light Emitting Diode (LED) driver.

5. The current limiting circuit according to claim 1, wherein the load is a light source.

6. The current limiting circuit according to claim 5, wherein the light source is at least one Light Emitting Diode (LED).

7. The current limiting circuit according to claim 1, wherein the switch is a transistor.

8. The current limiting circuit according to claim 7, wherein the transistor is partially operated in a linear mode.

9. The current limiting circuit according to claim 7, wherein the transistor is operated so as to control the rate of decrease of the output voltage.

10. The current limiting circuit according to claim 1, wherein the switch and the resistor are operatively coupled to one or more additional resistors and to one or more additional switches configured to control the rate of decrease of the output voltage to the substantially equilibrium level.

11. A current limiting circuit configured to limit the excess output current passing through a load, said current limiting circuit comprising a resistor connected in series with said load and in parallel with a switch, which is initially turned OFF, wherein said switch is configured to be turned ON, thereby shorting said resistor, when the output voltage is decreased by a predetermined level configured to allow a substantially brief surge of said excess output current to be passed through said load, and said switch configured to be turned OFF again when said output voltage is further decreased by an additional predetermined level, thereby continuously turning said switch ON and OFF until said output voltage is decreased to a substantially equilibrium level, at which said switch is left turned ON.

12. The current limiting circuit according to claim 11, wherein said current limiting circuit is integrated within a driver that is operatively coupled to the load.

13. The current limiting circuit according to claim 12, wherein the driver is a constant current driver.

14. The current limiting circuit according to claim 12, wherein the driver is a Light Emitting Diode (LED) driver.

15. The current limiting circuit according to claim 11, wherein the load is a light source.

16. The current limiting circuit according to claim 15, wherein the light source is at least one Light Emitting Diode (LED).

17. The current limiting circuit according to claim 11, wherein the output current passes through the load in brief pulses in excess of the predetermined current level until said predefined current level is substantially achieved.

18. The current limiting circuit according to claim 11, wherein the switch is a transistor.

19. The current limiting circuit according to claim 18, wherein the transistor is partially operated in a linear mode.

20. A method of limiting the excess output current passing through a load, said method comprising:
a) passing the excess output current through a resistor that is connected in series with a load and in parallel with a switch, which is initially turned OFF; and
b) when the output voltage is decreased by a predetermined level, turning ON said switch, thereby shorting said resistor and enabling further decreasing said output voltage to a substantially equilibrium level.

21. The method according to claim 20, wherein the load is a light source.

22. The method according to claim 20, wherein the switch is a transistor.

23. The method according to claim 22, further comprising partially operating the transistor in a linear mode.

24. The method according to claim 22, further comprising operating the transistor so as to control the rate of decrease of the output voltage.

25. The method according to claim 20, further comprising operatively coupling the switch and the resistor to one or more additional resistors and to one or more additional switches configured to control the rate of decreasing of the output voltage to the substantially equilibrium level.

26. A method of limiting the excess output current passing through a load, said method comprising:
a) passing the excess output current through a resistor that is connected in series with a load and in parallel with a switch, which is initially turned OFF;
b) when the output voltage is decreased by a predetermined level, turning ON said switch, thereby shorting said resistor and allowing a substantially brief surge of said excess output current to be passed through said load;
c) when the output voltage is further decreased by an additional predetermined level, turning OFF said switch; and
d) continuously repeating steps (c) and (d) until said output voltage is decreased to a substantially equilibrium level, at which said switch is left turned ON.

27. The method according to claim 26, further comprising passing the output current through the load in brief pulses in excess of the predetermined current level until said predefined current level is substantially achieved.

28. The method according to claim 26, wherein the load is a light source.

29. The method according to claim 26, wherein the switch is a transistor.

30. The method according to claim 29, further comprising partially operating the transistor in a linear mode.

31. A system configured to limit the excess output current passing through a load, said system comprising:
a) a driver configured to provide current to a load; and
b) a current limiting circuit operatively coupled to said driver and to said load, said current limiting circuit comprising a resistor connected in series with said load and in parallel with a switch, which is initially turned OFF, wherein said switch is turned ON, thereby shorting said resistor, when the output voltage applied to said load is decreased by a predetermined level.

32. The system according to claim 31, wherein the current limiting circuit is integrated within the driver.

33. The system according to claim 31, wherein the driver is a constant current driver.

34. The system according to claim 31, wherein the driver is a Light Emitting Diode (LED) driver.

35. The system according to claim 31, wherein the load is a light source.

36. The system according to claim 35, wherein the light source is at least one Light Emitting Diode (LED).

37. The system according to claim 31, wherein the switch is a transistor.

38. The system according to claim 37, wherein the transistor is partially operated in a linear mode.

39. The system according to claim 38, wherein the transistor is operated so as to control the rate of decrease of the output voltage.

40. The system according to claim 31, wherein the switch and the resistor are operatively coupled to one or more additional resistors and to one or more additional switches configured to control the rate of decreasing of the output voltage to the substantially equilibrium level.

41. A system configured to limit the excess output current passing through a load, said system comprising:
a) a driver configured to provide current to a load; and
b) a current limiting circuit operatively coupled to said driver and to said load, said current limiting circuit comprising a resistor, which is connected in series with said load and in parallel with a switch being initially turned OFF, wherein said switch is configured to be turned ON, thereby shorting said resistor, when the output voltage is decreased by a predetermined level configured to allow a substantially brief surge of said excess output current to be passed through said load, and said switch configured to be turned OFF again when said output voltage is further decreased by an additional predetermined level, thereby continuously turning said switch ON and OFF until said output voltage is decreased to a substantially equilibrium level, at which said switch is left turned ON.

42. The system according to claim 41, wherein the current limiting circuit is integrated within the driver.

43. The system according to claim 41, wherein the driver is a constant current driver.

44. The system according to claim 41, wherein the driver is a Light Emitting Diode (LED) driver.

45. The system according to claim 41, wherein the load is a light source.

46. The system according to claim 45, wherein the light source is at least one Light Emitting Diode (LED).

47. The system according to claim 41, wherein the output current passes through the load in brief pulses in excess of the predetermined current level until said predefined current level is substantially achieved.

48. The system according to claim 41 wherein the switch is a transistor.

49. The system according to claim 48, wherein the transistor is partially operated in a linear mode.
